(19) United States
(12) Patent Application Publication
(10) Pub. No.: US 2016/0140506 A1
(43) Pub. Date: May 19, 2016

(54) Systems and Methods for Candidate Recruiting

(71) Applicant: TextRecruit LLC, San Jose, CA (US)

(72) Inventors: Erik Kostelnik, San Jose, CA (US); John Edward Danner, San Jose, CA (US)

(73) Assignee: TextRecruit LLC

(21) Appl. No.: 14/943,539

(22) Filed: Nov. 17, 2015

Related U.S. Application Data
(60) Provisional application No. 62/080,816, filed on Nov. 17, 2014.

(51) Int. Cl. G06Q 10/10

(52) U.S. Cl. CPC G06Q 10/1053

(57) ABSTRACT

Systems and methods for communicating with recruiting candidates in accordance with embodiments of the invention are disclosed. In one embodiment, a candidate recruiting server system includes a processor and a memory connected to the processor, wherein the candidate recruiting server system obtains candidate data, where the candidate data includes direct communication channel data and candidate capability data, obtains job opportunity data describing one or more job opportunities, identifies a set of target candidate data based on the candidate capability data and the job opportunity data, generates communication data including the direct communication channel data for the set of target candidate data, and transmits the communication data to client devices associated with the direct communication channel within the generated communication data.

### CROSS-REFERENCE TO RELATED APPLICATIONS

The instant application claims priority to U.S. Provisional Patent Application No. 62/080,816, titled “Systems and Methods for Candidate Recruiting” and filed Nov. 17, 2014, the disclosure of which is hereby incorporated by reference in its entirety.

### FIELD OF THE INVENTION

The present invention relates to recruiting and more specifically to communicating with candidates.

### BACKGROUND

Applicant Tracking Systems (ATS) facilitate intake and tracking of applicants to one or more companies. Customer Relationship Management (CRM) systems are commonly employed to manage a variety of contacts with one or more companies. Many companies (i.e. employers) utilize recruiting agencies to identify potential employees. Recruiters post job openings, collect resumes from prospective employees, and conducts initial interviews of the prospective employee. The recruiter then recommends one or more potential employees to the companies.

### SUMMARY OF THE INVENTION

Systems and methods for communicating with recruiting candidates in accordance with embodiments of the invention are disclosed. In one embodiment, a candidate recruiting server system includes a processor and a memory connected to the processor, wherein the candidate recruiting server system obtains candidate data, where the candidate data includes direct communication channel data and candidate capability data, obtains job opportunity data describing one or more job opportunities, identifies a set of target candidate data based on the candidate capability data and the job opportunity data, generates communication data including the direct communication channel data for the set of target candidate data, and transmits the communication data to client devices associated with the direct communication channel within the generated communication data.

In an additional embodiment of the invention, the direct communication channel data includes a phone number.

In another embodiment of the invention, the communication data is transmitted via a short messaging service message.

In yet another additional embodiment of the invention, the direct communication channel includes an instant messaging account.

In still another additional embodiment of the invention, the communication data is transmitted via an online social network.

In yet still another additional embodiment of the invention, the candidate data is obtained from a recruiting agency database system.

In yet another embodiment of the invention, the candidate recruiting server system further provides the communication data to the recruiting agency database system.

In still another embodiment of the invention, the candidate data is obtained by processing bulk candidate data including header data and a set of raw candidate data.

In yet still another embodiment of the invention, the candidate recruiting server system further obtains command data identifying a piece of candidate data and including a specific command and updates the identified piece of candidate data based on the specific command.

In yet another additional embodiment of the invention, the specific command includes an unsubscribe command.

Still another embodiment of the invention includes a method for candidate recruiting including obtaining candidate data using a candidate recruiting server system, where the candidate data includes direct communication channel data and candidate capability data and the candidate recruiting server system includes a processor and a memory connected to the processor, obtaining job opportunity data describing one or more job opportunities using the candidate recruiting server system, identifying a set of target candidate data based on the candidate capability data and the job opportunity data using the candidate recruiting server system, generating communication data including the direct communication channel data for the set of target candidate data using the candidate recruiting server system, and transmitting the communication data to client devices associated with the direct communication channel within the generated communication data using the candidate recruiting server system.

In yet another additional embodiment of the invention, the direct communication channel data includes a phone number.

In still another additional embodiment of the invention, the communication data is transmitted via a short messaging service message.

In yet still another additional embodiment of the invention, the direct communication channel includes an instant messaging account.

In yet another embodiment of the invention, the communication data is transmitted via an online social network.

In still another embodiment of the invention, the candidate data is obtained from a recruiting agency database system.

In yet still another embodiment of the invention, the method further includes providing the communication data to the recruiting agency database system using the candidate recruiting server system.

In yet another additional embodiment of the invention, the candidate data is obtained by processing bulk candidate data including header data and a set of raw candidate data.

In still another additional embodiment of the invention, the method further includes obtaining command data identifying a piece of candidate data and including a specific command using the candidate recruiting server system and updating the identified piece of candidate data based on the specific command using the candidate recruiting server system.

In yet still another additional embodiment of the invention, the specific command includes an unsubscribe command.

### BRIEF DESCRIPTION OF THE DRAWINGS

FIG. 1A is a conceptual illustration of a candidate recruiting system in accordance with an embodiment of the invention.

FIG. 1B is a conceptual illustration of an application programming interface for communicating with recruiting candidates in accordance with an embodiment of the invention.

FIG. 2 is a conceptual illustration of a candidate recruiting server system in accordance with an embodiment of the invention.

FIG. 3A is a flow chart illustrating a process for communicating with recruiting candidates in accordance with an embodiment of the invention.

FIG. 3B is a conceptual illustration of a user interface for creating message data in accordance with an embodiment of the invention.

FIG. 4A is a flow chart illustrating a process for creating candidate data in accordance with an embodiment of the invention.

FIGS. 4B and 4C are conceptual illustrations of user interfaces for obtaining candidate data in accordance with an embodiment of the invention.

FIG. 5A is a flow chart illustrating a process for generating message template data in accordance with an embodiment of the invention.

FIG. 5B is a conceptual illustration of a user interface for creating message template data in accordance with an embodiment of the invention.

FIG. 6A is a flow chart illustrating a process for tracking communication data in accordance with an embodiment of the invention.

FIG. 6B is a conceptual illustration of a user interface for tracking communications in accordance with an embodiment of the invention.

### DETAILED DESCRIPTION

Turning now to the drawings, systems and methods for candidate recruiting systems in accordance with embodiments of the invention are disclosed. Recruiting agencies commonly represent a large number of candidates and employers (e.g. hiring companies). The recruiting agencies measure the skills, experience, and/or desired positions of the candidates and obtain references to job opportunities at the employers. The recruiting agencies can then refer candidates who are a good fit for the employer's needs and, if the candidate is hired by the employer, receive a fee for referring the candidate. Accordingly, recruiting agencies have a need to communicate effectively with candidates, both to inform them of potential opportunities and to convince the candidate to work with the recruiting agency.

Candidate recruiting systems in accordance with embodiments of the invention facilitate communication between recruiting agencies and candidates by providing a central location for recruiting teams to send, manage, and track direct communication data with candidates without use of a personal phone by recruiters or recruiting agencies. Candidate recruiting systems can perform as stand-alone systems and/or be integrated into an applicant tracking system, customer relationship management system, job board service, or any other third-party service as appropriate to the requirements of specific applications of embodiments of the invention. Candidate recruiting systems can utilize direct text messaging via short messaging services (SMS), instant messaging (IM), messages sent via an online social network, or any other communication medium that is pushed directly to a candidate's device. Candidate devices include, but are not limited to, mobile phones and tablet devices. In several embodiments, candidate recruiting systems directly message candidates via one or more third-party services such as online social networks. In particular, these direct messages have a much higher engagement rate with potential candidates than less direct communication techniques such as email. However, direct messages are much more difficult to create, communicate, and track than email and candidate recruiting systems utilize a variety of processes to generate, transmit, and track direct messages with candidates.

In a variety of embodiments, candidate recruiting systems obtain telephone numbers for one or more recruiters associated with a recruiting agency and these telephone numbers are utilized to communicate with candidates. In the event that a recruiter leaves the recruiting agency, the number and any associated communication data can be assigned to a different recruiter. In this way, the communication data can be continuously maintained by the recruiting agency. Furthermore, the tracking of telephone number data and communication data facilities the division of labor between different recruiters in a recruiting agency and reduces duplicative recruiting of the same candidate. In several embodiments, candidate recruiting systems include obtaining job opportunity data from a variety of job board services and/or employers and utilizing the job opportunity data to create a local job board repository. The candidate recruiting systems can then utilize the local job board repository as the source of job opportunity data. Additionally, performance metrics for the recruiters and recruiting process can be measured and analyzed.

Systems and methods for candidate recruiting in accordance with embodiments of the invention are discussed in detail below.

### Candidate Recruiting Systems

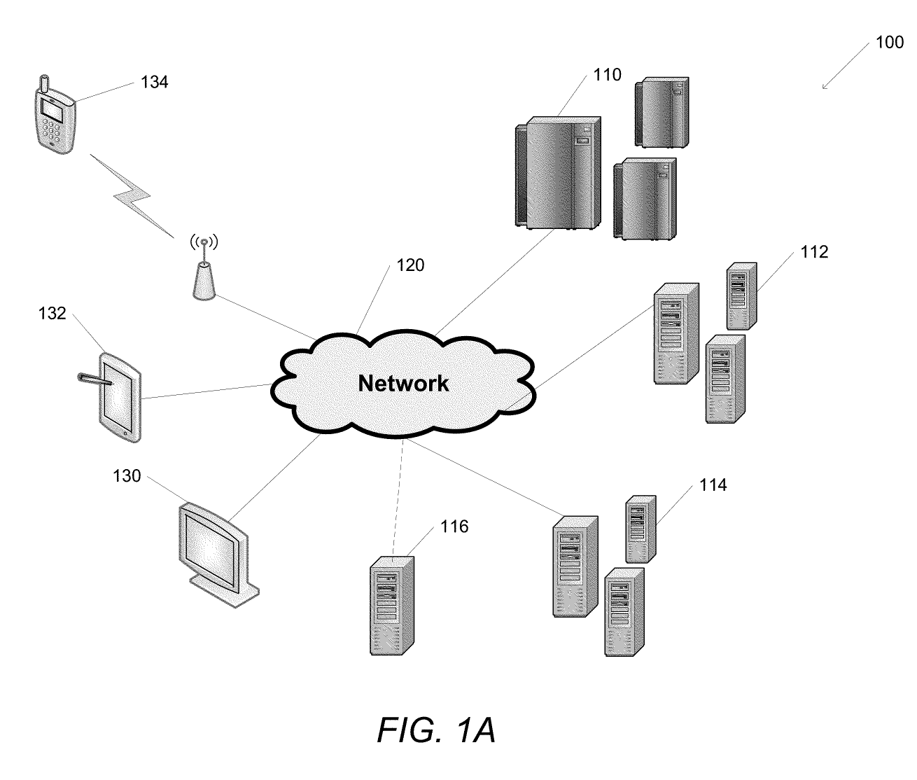

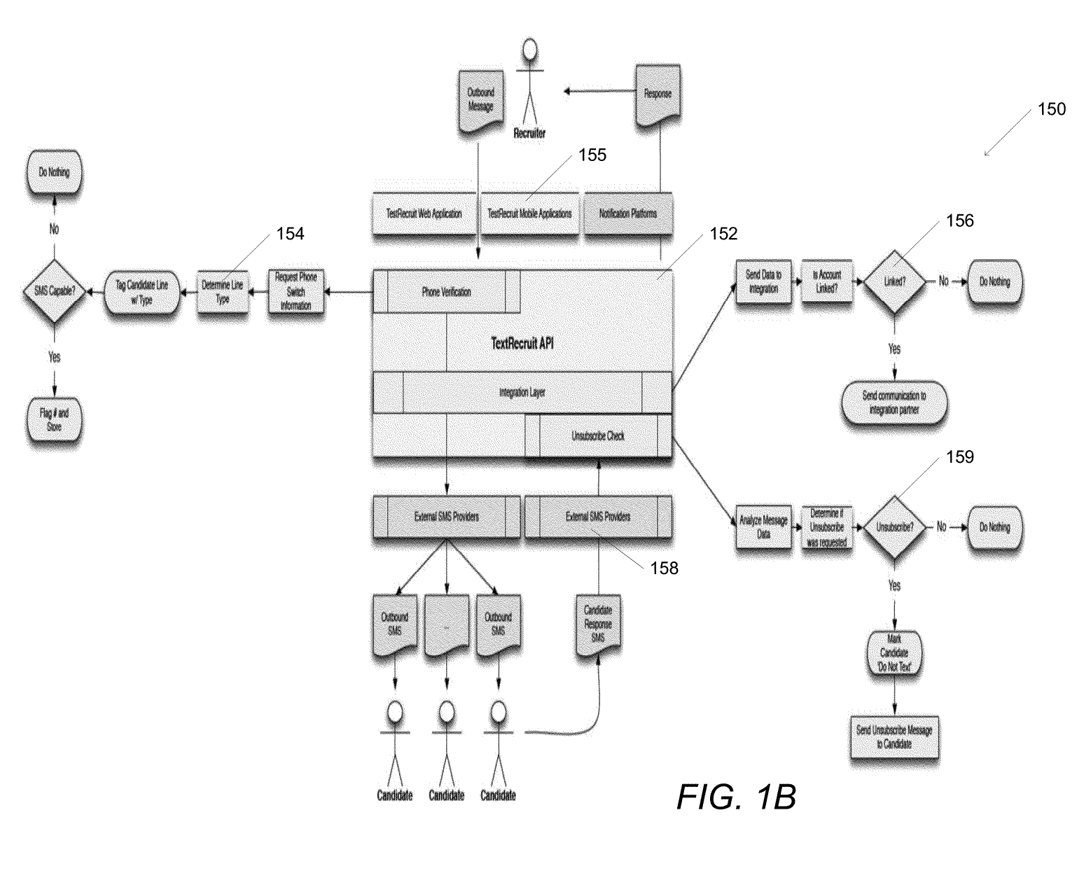

Candidate recruiting systems in accordance with embodiments of the invention are configured to directly message one or more candidates and track the messages and corresponding responses. A conceptual diagram of a candidate recruiting system in accordance with an embodiment of the invention is shown in FIG. 1A. The candidate recruiting system 100 includes a candidate recruiting server system 110, a recruiting agency database system 112, third-party content systems 114, and user devices including computers 130, tablets 132, and mobile phones 134 configured to communicate via a network 120. User devices can be associated with a candidate and/or a recruiter as appropriate to the requirements of specific applications of the invention. In a variety of embodiments, the network 120 is the Internet. In a number of embodiments, the candidate recruiting server system 110 and/or the recruiting agency database system 112 are implemented using a single server system. In several embodiments, the candidate recruiting server system 110 and/or recruiting agency database system 112 are implemented using multiple server systems. In a variety of embodiments, a third-party messaging system 116 is connected to the network.

The candidate recruiting server system 110 can obtain candidate data regarding one or more potential candidates and transmit messages to user devices associated with the candidates. Additionally, the candidate recruiting server system 110 can obtain responses to the messages and associate the response data with candidate message data in order to track the communications between a particular recruiter (i.e. phone number assigned by the candidate recruiting server system 110) and candidate. In a variety of embodiments, candidate recruiting server system 110 obtains job opportunity data from the recruiting agency database system 112 and/or the third-party content systems 114. Recruiting agency database systems 112 include, but are not limited to, application tracking systems, customer relationship management systems, and any other system providing candidate data. In many embodiments, the candidate recruiting server system 110 provides communication data to the third-party messaging system 116. The third-party messaging system 116 can utilize the communication data to transmit messages directly to the appropriate user devices. In this way, the candidate recruiting server system 110 can provide direct messages to candidates across a variety of communication channels without incurring the development cost or overhead of communicating via those communication channels.

It should be noted that the candidate data and/or job opportunity data can be obtained from any system in any manner (i.e. via one or more application programming interfaces (APIs) or web services) as appropriate to the requirements of specific applications of embodiments of the invention. Similarly, communication data (or any other data) can be communicated utilizing any of a variety of APIs. A conceptual illustration of an application programming interface 150 for performing a variety of candidate recruiting processes in accordance with an embodiment of the invention is shown in FIG. 1B. The API 150 includes a candidate recruiting API 152 providing a variety of interfaces, including a phone verification interface 154, a user interface interface 155, a database system interface 156, a direct message interface 158, and a communication control interface 159. As described in more detail below, the phone verification interface 154 can be utilized to verify the direct message contact information for a candidate, the user interface interface 155 can be utilized to provide and receive a variety of data utilized by a candidate recruiting server system, database system interface 156 can be utilized to transmit data to/from recruiting agency database systems (and/or any other third-party system), direct message interface 158 can be utilized to transmit direct messages to user devices (both directly and via third-party messaging systems), and communication control interface 159 can be utilized to control the messages sent to particular user devices. However, it should be noted that any subset of these interfaces, combinations of interfaces, and/or additional interfaces not specifically illustrated can be utilized as appropriate to the requirements of specific applications of embodiments of the invention.

Although a specific architecture of a candidate recruiting system and an associated API in accordance with embodiments of the invention are discussed above and illustrated in FIGS. 1A and 1B, a variety of architectures, including user devices not specifically named and other third-party systems and services, such as customer relationship management systems, and alternative APIs can be utilized in accordance with embodiments of the invention.

### Candidate Recruiting Server Systems

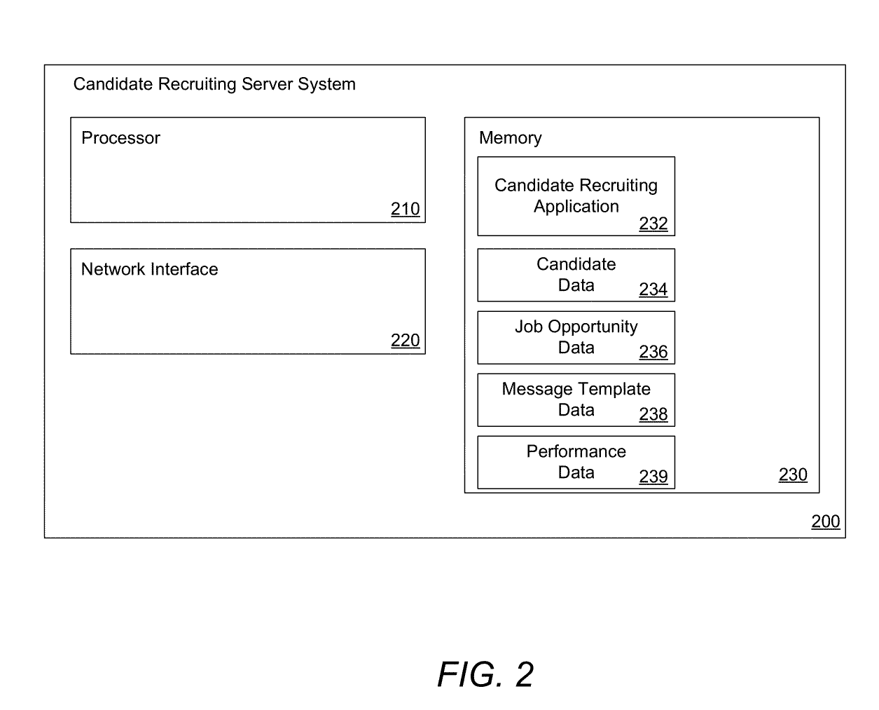

Candidate recruiting server systems in accordance with embodiments of the invention transmit message data to candidate devices, obtain responses to the message data, and associate the responses and the message data in order to track the communications. A conceptual illustration of a candidate recruiting server system in accordance with an embodiment of the invention is shown in FIG. 2. The candidate recruiting server system 200 includes a processor 210 in communication with memory 230. The candidate recruiting server system 200 also includes a network interface 220 configured to send and receive data over a network connection. In a number of embodiments, the network interface 220 is in communication with the processor 210 and/or the memory 230. In several embodiments, the memory 230 is any form of storage configured to store a variety of data, including, but not limited to, a candidate recruiting application 232, candidate data 234, job opportunity data 236, message template data 238, and performance data 239. In many embodiments, the candidate recruiting application 232, candidate data 234, job opportunity data 236, message template data 238, and/or performance data 239 are stored using an external server system and received by the candidate recruiting server system 200 using the network interface 220.

The processor 210 is directed by the candidate recruiting application 232 to perform a variety of candidate recruiting processes. These processes include obtaining candidate data 234, job opportunity data 236, and/or message template data 238. These pieces of data can be obtained from any systems, such as recruiting agency database systems, third-party content systems, client devices, the candidate recruiting server system itself, or any other system as appropriate to the requirements of specific applications of embodiments of the invention. Candidate recruiting processes include utilizing the candidate data 234 and/or job opportunity data 236 to generate message data to be transmitted to user devices identified in the candidate data 234. Additionally, message template data 238 can be defined so that particular messages can be sent to one or more candidate devices in an efficient manner.

Candidate data 234 can include the candidate's name, telephone number, direct contact information, demographic information, metadata describing the candidate's skills and/or desired position, current geographic location, desired geographic location, and/or any other data describing the candidate. Job opportunity data 236 can include employer data, geographic information, salary data, start date information, desired skill data, and/or any other data describing a particular job opportunity. Message template data 238 can include text data, a reference to a particular job opportunity, attributes regarding candidates and/or job opportunities, dates to be transmitted, recruiter(s) associated with the message template, and any other data describing the messages and how the messages should be tracked. In several embodiments, Message template data 238 includes placeholders for one or more attributes, such as candidate name, a reference to a job opportunity posted on a third-party service, an employer name, salary information, and any other data associated with the candidate, employer, recruiting agency, and/or job opportunity. It should be noted that any other data can be included in the candidate data 234, job opportunity data 236, and/or message template data 238 as appropriate to the requirements of specific applications of embodiments of the invention. Performance data 239 can include, but is not limited to, number of candidates contacted, response rate, job postings advertised, referrals made, candidates hired, candidates rejected, and any other performance metric as appropriate to the requirements of specific applications of the invention.

Although a specific architecture for a candidate recruiting server system in accordance with an embodiment of the invention is conceptually illustrated in FIG. 2, any of a variety of architectures, including those which store data or applications on disk or some other form of storage and are loaded into memory at runtime and systems that are distributed across multiple physical servers, can also be utilized in accordance with embodiments of the invention. In a variety of embodiments, the memory 220 includes circuitry such as, but not limited to, memory cells constructed using transistors, that are configured to store instructions. Similarly, the processor 210 can include logic gates formed from transistors (or any other device) that are configured to dynamically perform actions based on the instructions stored in the memory. In several embodiments, the instructions are embodied in a configuration of logic gates within the processor to implement and/or perform actions described by the instructions. In this way, the systems and methods described herein can be performed utilizing both general-purpose computing hardware and by single-purpose devices.

Communicating with Candidates

Candidate recruiting process can include transmitting communication data to a variety of candidate devices along with tracking responses to the communication data. Additionally, candidate recruiting process can include obtaining information regarding job opportunities from a variety of sources, such as job board services, direct contacts, employer websites, and any other sources of job opportunities employed in a number of embodiments. Candidate recruiting processes can also include automatically obtaining telephone numbers for one or more recruiters and utilize these telephone numbers to engage in direct communication with one or more candidate devices. This also provides a variety of advantages in that individual recruiters no longer need to utilize their personal telephone numbers to communicate with candidates. These telephone numbers can then be used to organize and track communications conducted via the telephone numbers. Similarly, the telephone numbers can be assigned to one or more recruiters at a recruiting agency. In a variety of embodiments, a telephone number (or any other direct communication channel) is verified to ensure that the communication data is transmitted to a valid client device.

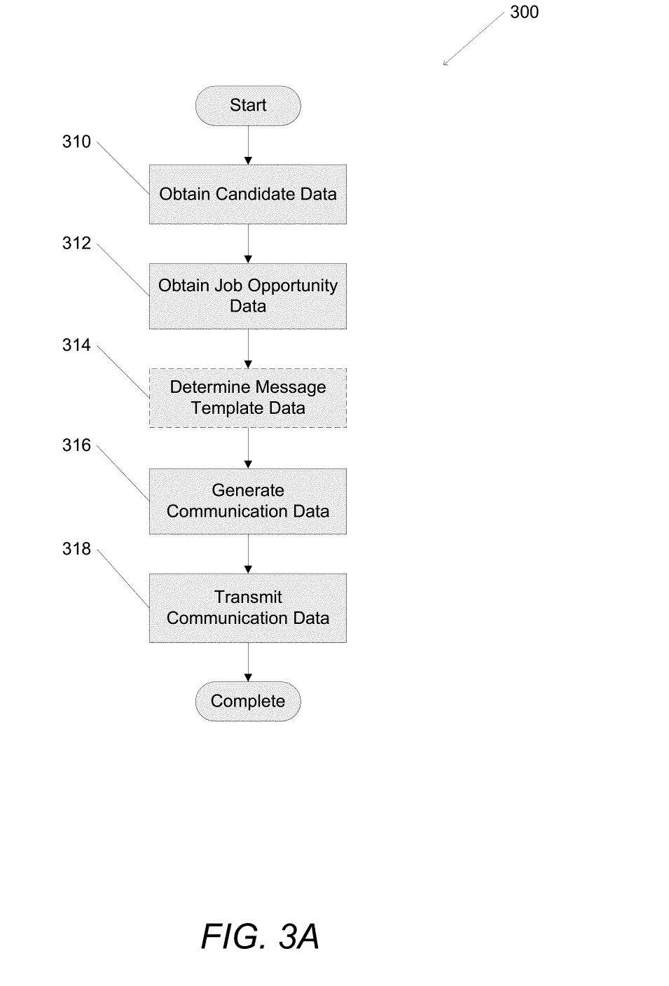

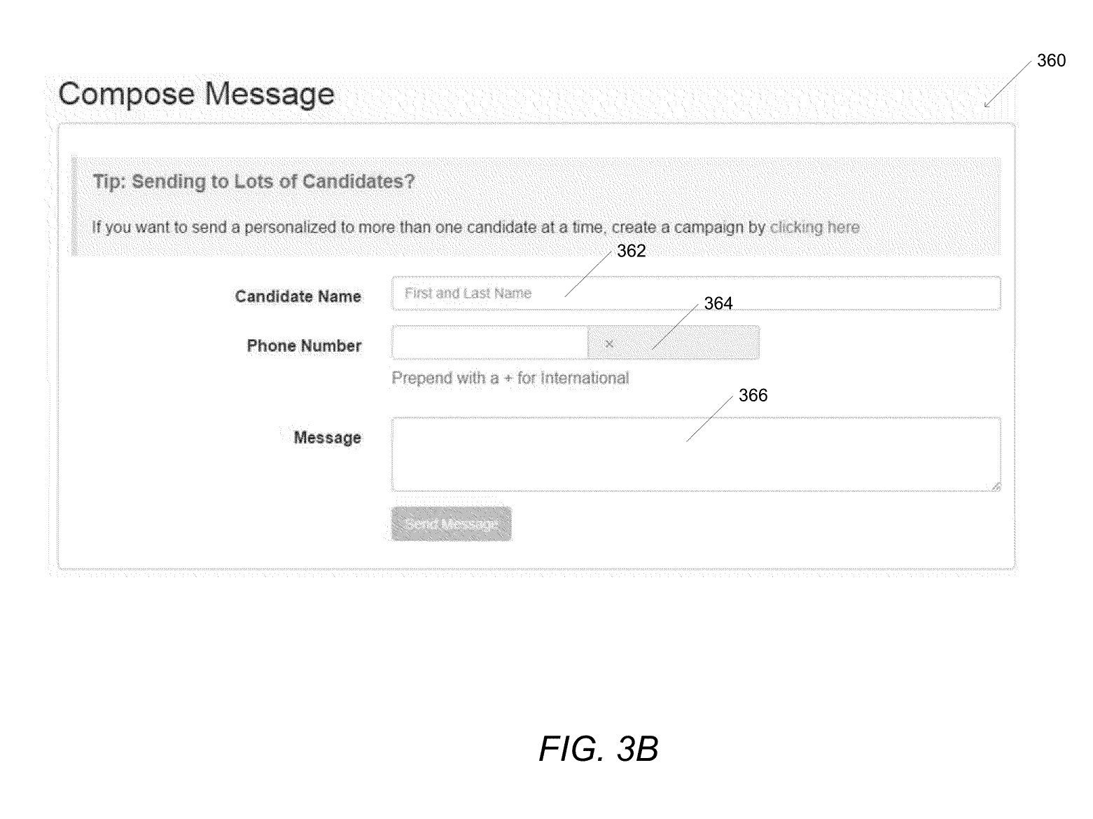

A process for tracking candidates and determining missed fee opportunities in accordance with an embodiment of the invention is illustrated in FIG. 3A. The process 300 includes obtaining (310) candidate data, obtaining (312) job opportunity data, and, in many embodiments, determining (314) message template data. Communication data is generated (316) and transmitted (318).

A conceptual illustration of a user interface for generating communication data in accordance with an embodiment of the invention is shown in FIG. 3B. The user interface 360 includes the ability to enter candidate name data 362, direct communication channel data 364 (e.g. a phone number), and communication data 366. In many embodiments the user interface is pre-filled and/or partially filled based on message template data. The message template data can be applied automatically and/or based on the candidate name data and/or direct communication channel data as appropriate to the requirements of specific applications of embodiments of the invention.

Although specific processes, application programming interfaces, and user interfaces for communicating with candidates in accordance with embodiments of the invention are described above with respect to FIGS. 3A and 3B, any number of processes and user interfaces can be utilized as appropriate to the requirements of a specific application in accordance with embodiments of the invention.

### Creating Candidate Data

Candidate recruiting processes can include creating candidate data in a variety of ways in accordance with embodiments of the invention. In a variety of embodiments, raw candidate data is obtained from one or more recruiting agency systems (i.e. from an applicant tracking system and/or a customer relationship management system) and/or job board services. Raw candidate data can also be entered directly, either individually or in bulk (such as text data or obtained from a database management system). In a variety of embodiments, the raw candidate data is validated during the creation of candidate data. For example, phone number data included in the raw data can be verified to ensure that the phone numbers have the ability to receive direct messages (i.e. text messages). If the phone number is valid, it can be included in the candidate data as a valid direct communication channel. If the phone number is not valid, it can be disregarded and/or reviewed as appropriate to the requirements of specific applications of embodiments of the invention.

Furthermore, metadata identifying the recruiting agency system can be associated with the candidate data. This metadata can be utilized in a variety of instances, such as providing updated candidate data to the recruiting agency system based on communication data communicated to the candidate and/or commands received from a client device. It should be noted that any of a variety of processes for communicating data with recruiting agency systems can be utilized as appropriate to the requirements of specific applications of embodiments of the invention.

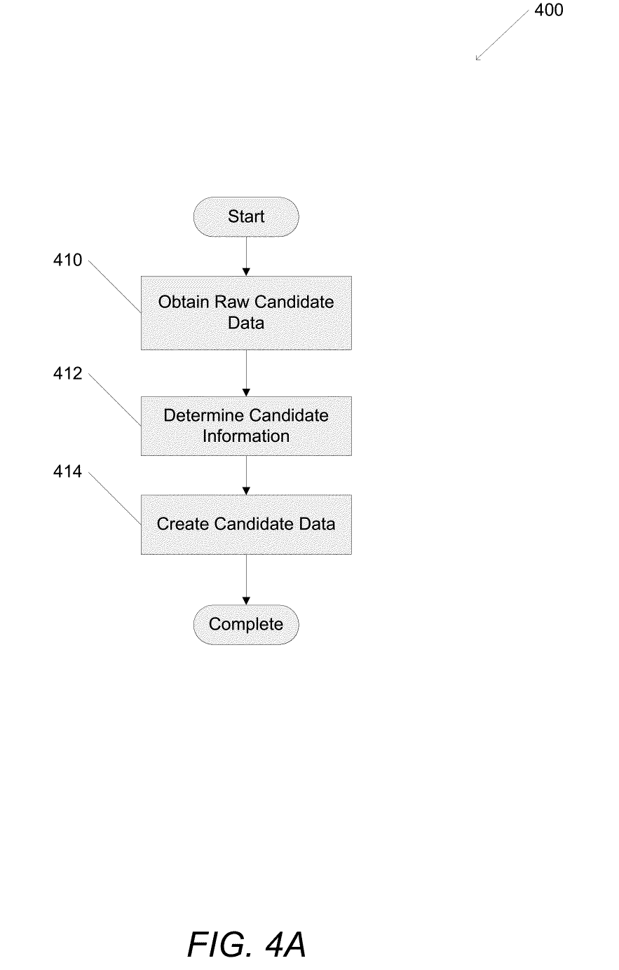

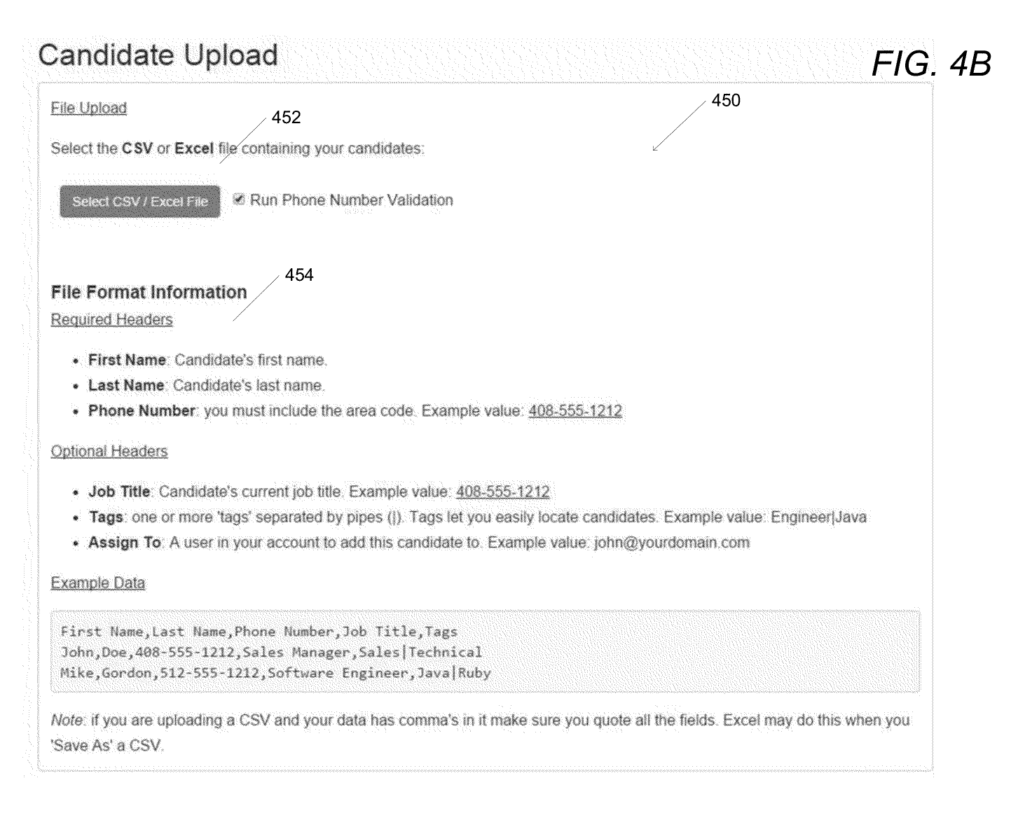

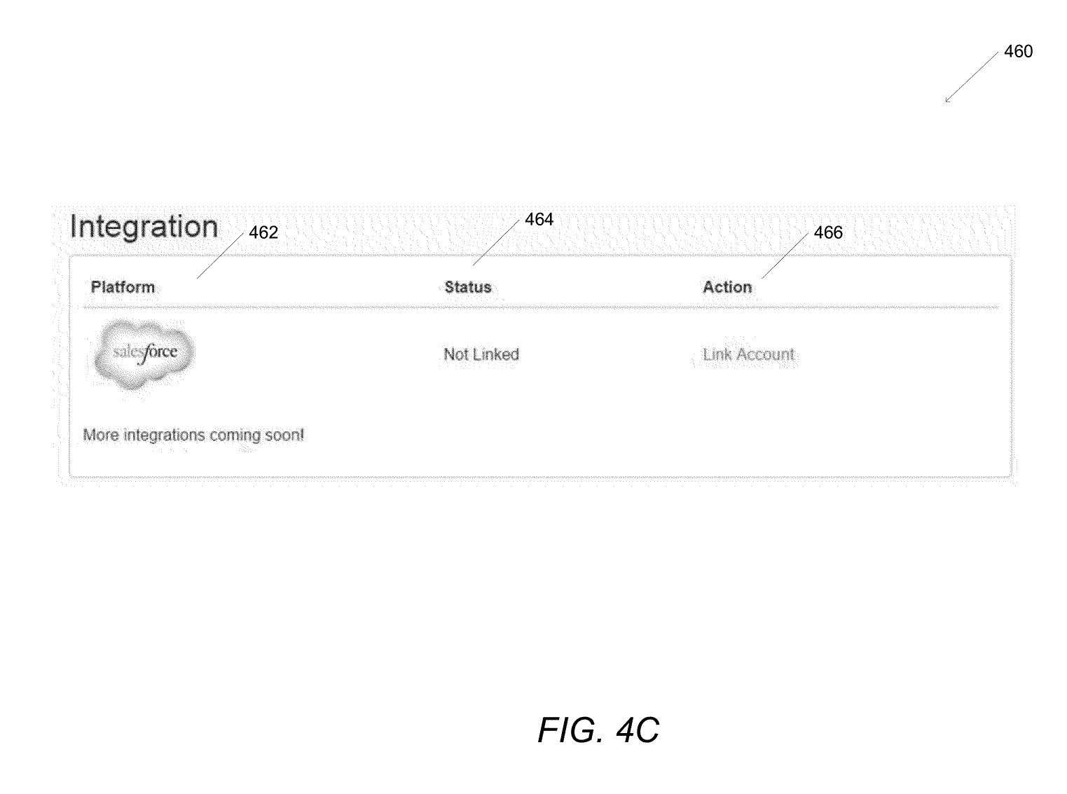

A process for creating candidate data in accordance with an embodiment of the invention is illustrated in FIG. 4A. The process 400 includes obtaining (410) raw candidate data, determining (412) candidate information, and creating (414) candidate data.

A conceptual illustration of a user interface for bulk uploading of raw candidate data in accordance with an embodiment of the invention is shown in FIG. 4B. The user interface 450 includes a file upload selection 452 and formatting tips 454. The file upload selection 452 allows for the selection and upload of bulk candidate data, along with providing the option of validating some or all of the uploaded data. The formatting tips 454 provide examples of the expected format of the bulk candidate data. For example, the bulk candidate data can include header data and a set of raw candidate data. The header data can include a variety of categories, including but not limited to first name, last name, direct communication channel data, job data, tag data, and recruiter data. The raw candidate data (i.e. the rows in the bulk candidate data) can include specific values for the candidate data, such as the name data, direct communication channel data, job data, tag data, and recruiter data. The bulk candidate data can be formatted in any of a variety of manners as appropriate to the requirements of specific applications of embodiments of the invention, including comma separated, tab separated, and spreadsheets.

A conceptual illustration of a user interface for obtaining raw candidate data from an applicant tracking system in accordance with an embodiment of the invention is shown in FIG. 4C. The user interface 460 includes a listing of recruiting agency systems 462, status data 464, and actions 466. In the illustrated embodiment, the status data 464 indicates if the corresponding recruiting agency system is capable of communicating with the recruit tracking server system and the actions 466 provide the ability to establish communication with the recruiting agency system. However, it should be noted that any of a variety of statuses and actions can be shown and executed in the user interface as appropriate to the requirements of specific applications of embodiments of the invention,

Although specific processes and user interfaces for creating candidate data in accordance with embodiments of the invention are described above with respect to FIGS. 4A-C, any number of processes, including those that obtain (raw) candidate data from systems other than those specifically described above, and alternative user interfaces can be utilized as appropriate to the requirements of a specific application in accordance with embodiments of the invention.

### Generating Message Templates

A number of candidate recruiting processes include transmitting messages to a number of candidates. Additionally, it may be desirable to have a consistent messaging format. For example, a particular message template can have a superior response rate (relative to other messages) and the performance of the candidate recruiting processes can be improved by utilizing the particular message template. In many embodiments, message template data includes a job opportunity reference that includes a shortened uniform resource locator (URL) provided by a candidate tracking server system and the shortened URL allows tracking of engagement with the URL. This facilitates the customization of the message sent to each candidate so that the transmitted messages appear to be targeted directly to the candidate. In many embodiments, the message template (or the message generated by the message template) has a length limitation. For example, communications sent via a small messaging service can be limited to 160 characters. Furthermore, time data can be associated with the message templates so that messages are automatically sent at particular times. For example, the messages (i.e. communication data) can be sent during business hours. In several embodiments, geolocation data is associated with the candidate data and the geolocation data can be utilized to determine time offset data for a particular candidate. In this way, the timing of messages can be adjusted based on the location of the candidate to ensure that messages are not delivered at inappropriate times. The message templates can be associated with one or more recruiters, employers, job opportunities, and/or candidates as appropriate to the requirements of specific applications of the invention. Candidate recruiting processes can also include tracking the performance of messages sent out using a particular message template.

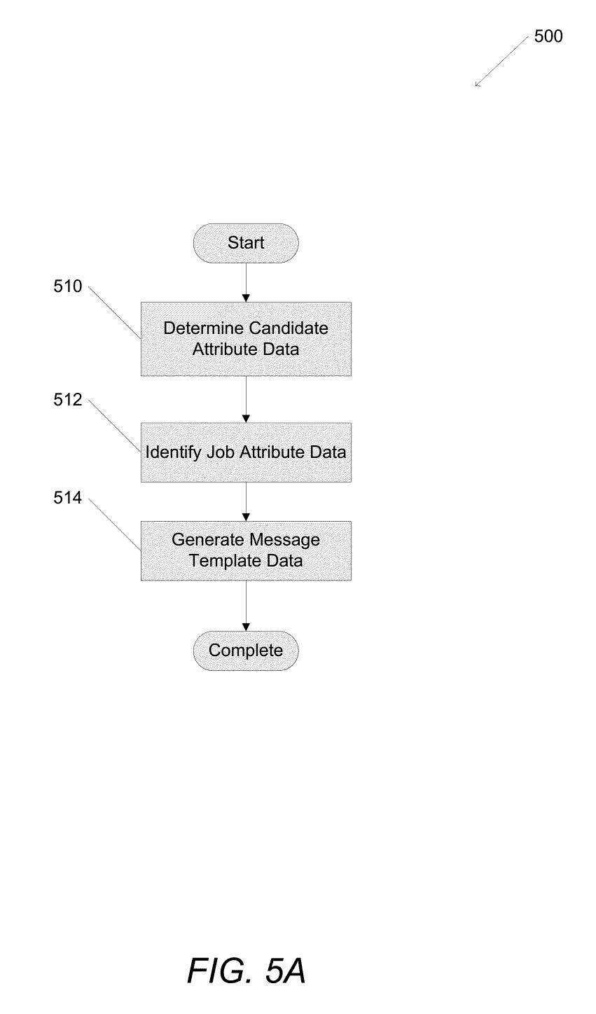

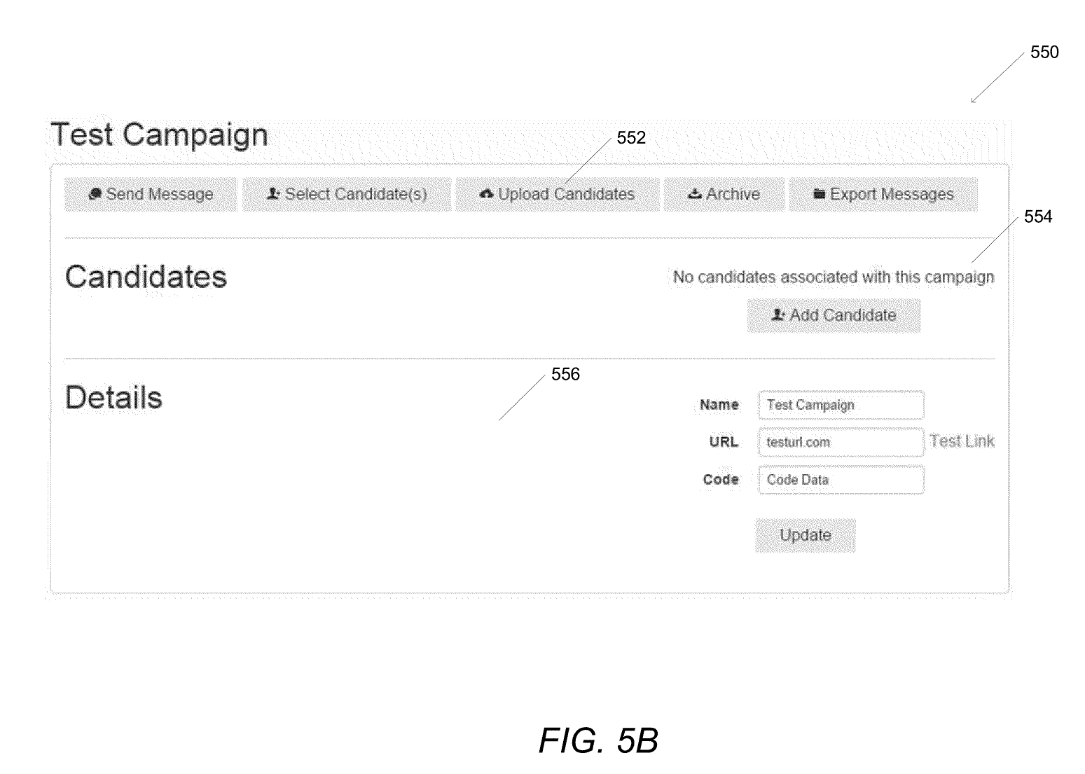

A process for generating message template data in accordance with an embodiment of the invention is illustrated in FIG. 5A. The process 500 includes determining (510) candidate attribute data, identifying (512) job attribute data, and generating (514) message template data.

A conceptual illustration of a user interface for generating message template data in accordance with an embodiment of the invention is shown in FIG. 5B. The user interface 550 includes message commands 552, candidate list 554, and template details 556. The message commands 552 can include any command relevant to the message template and/or campaign, including sending messages, selecting candidates, uploading candidate data, archiving data, and exporting data. The candidate list 554 can include a set of candidate data identifying the candidates that are targeted by the specific campaign and/or template data. The template details 556 can include any data related to the message template, the campaign, and any other metadata as appropriate to the requirements of specific applications of embodiments of the invention.

Specific processes and interfaces for generating message template data in accordance with embodiments of the invention are described above with respect to FIGS. 5A-B; however, any number of processes and interfaces can be utilized as appropriate to the requirements of a specific application in accordance with embodiments of the invention.

### Tracking Communications

Candidate recruiting processes in accordance with embodiments of the invention can include tracking communications with candidates. Once communication data has been transmitted to a candidate device, the candidate can read and respond to the communication. Communication data can be sent immediately and/or scheduled for future communication as appropriate to the requirements of specific applications of the invention. In several embodiments, a candidate generates response data describing their level of interest in the opportunity described in the communication data. When the candidate responds, the response data can be obtained and associated with a telephone number associated with one or more recruiters. In a number of embodiments, the telephone number corresponds to the telephone number associated with the communication data, although the response data can be associated with a different telephone number. In this way, one or more recruiters can be associated with a particular telephone number so that the absence of any one recruiter does not affect the relationship with the candidate. Additionally, notifications can be generated when response data is received that alert the recruiter(s) that a message has been received. Additionally, performance metrics related to the communication data and response data can be measured as appropriate to the requirements of specific applications of embodiments, of the invention.

Response data can also include command metadata describing particular actions that the candidate wishes a candidate recruiting server system to take. For example, a candidate can reply ‘unsubscribe’ or ‘stop’ in order to stop receiving communication data. Similarly, a candidate can reply ‘subscribe’ or ‘resubscribe’ in order to start receiving communication data. Any other commands can be included in response data as appropriate to the requirements of specific applications of embodiments of the invention. The commands can be received and/or executed by the candidate recruiting server system and/or any third-party systems as appropriate to the requirements of specific applications of embodiments of the invention.

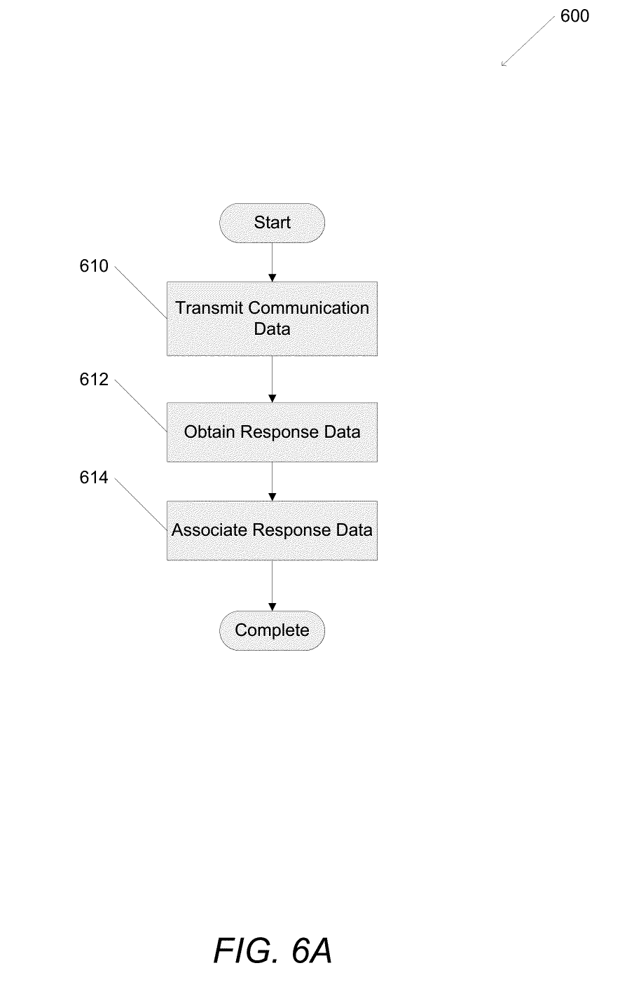

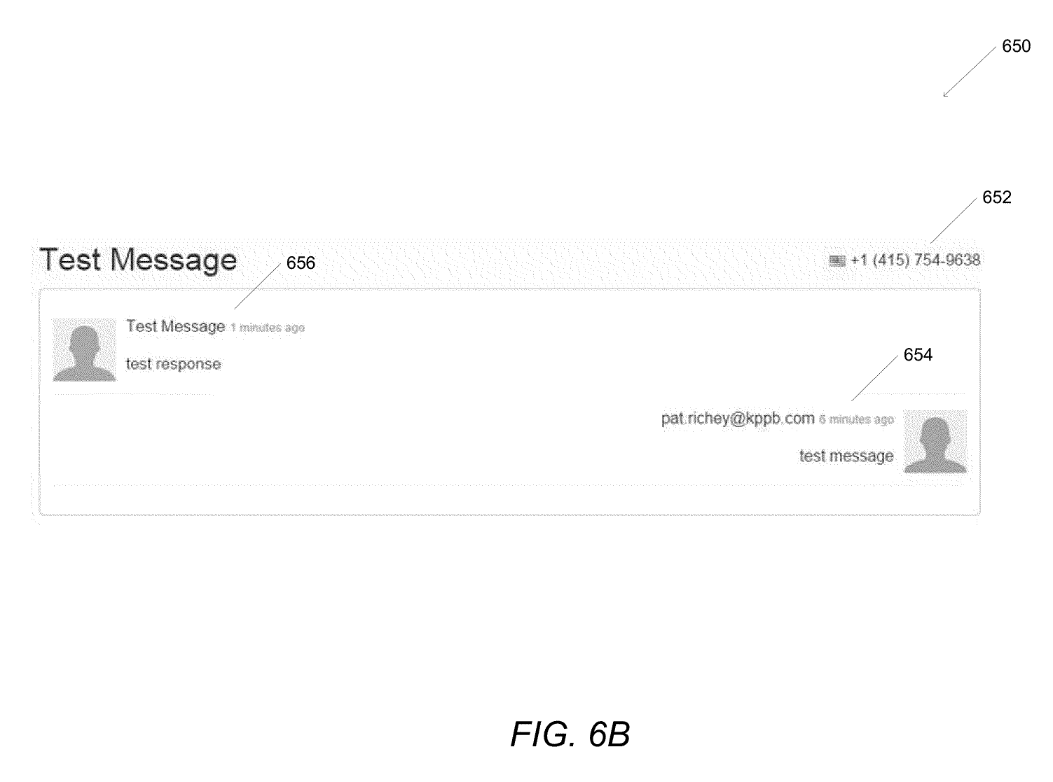

A process for tracking communication data in accordance with an embodiment of the invention is illustrated in FIG. 6. The process 600 includes transmitting (610) communication data, obtaining (612) response data, and associating (614) response data.

A conceptual illustration of a user interface for tracking communication data is shown in FIG. 6B. The user interface 650 includes communication channel data 652, sent messages 654, and received messages 656.

Specific processes and interfaces for tracking communication data in accordance with embodiments of the invention are described above with respect to FIGS. 6A-B; however, any number of processes and interfaces can be utilized as appropriate to the requirements of a specific application in accordance with embodiments of the invention.

Although the present invention has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A candidate recruiting server system, comprising:
a processor; and
a memory connected to the processor;
wherein the candidate recruiting server system:
obtains candidate data, where the candidate data comprises direct communication channel data and candidate capability data;
obtains job opportunity data describing one or more job opportunities;
identifies a set of target candidate data based on the candidate capability data and the job opportunity data;
generates communication data comprising the direct communication channel data for the set of target candidate data; and
transmits the communication data to client devices associated with the direct communication channel within the generated communication data.

2. The candidate recruiting server system of claim 1, wherein the direct communication channel data comprises a phone number.

3. The candidate recruiting server system of claim 2, wherein the communication data is transmitted via a short messaging service message.

4. The candidate recruiting server system of claim 1, wherein the direct communication channel comprises an instant messaging account.

5. The candidate recruiting server system of claim 4, wherein the communication data is transmitted via an online social network.

6. The candidate recruiting server system of claim 1, wherein the candidate data is obtained from a recruiting agency database system.

7. The candidate recruiting server system of claim 6, wherein the candidate recruiting server system further provides the communication data to the recruiting agency database system.

8. The candidate recruiting server system of claim 1, wherein the candidate data is obtained by processing bulk candidate data comprising header data and a set of raw candidate data.

9. The candidate recruiting server system of claim 1, wherein the candidate recruiting server system further:
obtains command data identifying a piece of candidate data and comprising a specific command; and
updates the identified piece of candidate data based on the specific command.

10. The candidate recruiting server system of claim 9, wherein the specific command comprises an unsubscribe command.

11. A method for candidate recruiting, comprising:
obtaining candidate data using a candidate recruiting server system, where:
the candidate data comprises direct communication channel data and candidate capability data; and
the candidate recruiting server system comprises a processor and a memory connected to the processor;
obtaining job opportunity data describing one or more job opportunities using the candidate recruiting server system;
identifying a set of target candidate data based on the candidate capability data and the job opportunity data using the candidate recruiting server system;
generating communication data comprising the direct communication channel data for the set of target candidate data using the candidate recruiting server system; and
transmitting the communication data to client devices associated with the direct communication channel within the generated communication data using the candidate recruiting server system.

12. The method of claim 11, wherein the direct communication channel data comprises a phone number.

13. The method of claim 12, wherein the communication data is transmitted via a short messaging service message.

14. The method of claim 11, wherein the direct communication channel comprises an instant messaging account.

15. The method of claim 14, wherein the communication data is transmitted via an online social network.

16. The method of claim 11, wherein the candidate data is obtained from a recruiting agency database system.

17. The method of claim 16, further comprising providing the communication data to the recruiting agency database system using the candidate recruiting server system.

18. The method of claim 11, wherein the candidate data is obtained by processing bulk candidate data comprising header data and a set of raw candidate data.

19. The method of claim 11, further comprising:
obtaining command data identifying a piece of candidate data and comprising a specific command using the candidate recruiting server system; and
updating the identified piece of candidate data based on the specific command using the candidate recruiting server system.

20. The method of claim 19, wherein the specific command comprises an unsubscribe command.
